(19) United States
(12) Patent Application Publication
(10) Pub. No.: US 2014/0093759 A1
(43) Pub. Date: Apr. 3, 2014

(54) LITHIUM-ION SECONDARY BATTERY

(71) Applicant: Hitachi, Ltd., Chiyoda-ku (JP)

(72) Inventors: Norio Iwayasu, Tokyo (JP); Masanori Yoshikawa, Tokyo (JP); Hidetoshi Honbou, Tokyo (JP)

(21) Appl. No.: 14/123,921

(22) PCT Filed: Jun. 13, 2011
(86) PCT No.: PCT/JP2011/003326

§ 371 Date: Dec. 4, 2013

(51) Int. Cl. H01M 2/34

(52) U.S. Cl. CPC H01M 2/345
USPC 429/61

(57) ABSTRACT

A lithium-ion secondary battery having a positive electrode capable of occluding and releasing lithium ions, a negative electrode capable of occluding and releasing lithium ions, a separator interposed between the positive electrode and the negative electrode, an electrolytic solution, and a current breaking mechanism that activates in response to the rise of the battery's internal pressure, wherein the electrolytic solution is incorporated with an aromatic compound and the separator is incorporated with a carbon dioxide gas generating agent which is represented by the formula AₓCO₃ or A_{y}HCO₃. It is highly responsive to overcharging owing to the current breaking mechanism attached thereto which activates in the early stage of overcharging. Therefore, it exhibits high battery performance as well as high safety in the case of overcharging.

### TECHNICAL FIELD

The present invention relates to a lithium-ion secondary battery.

### BACKGROUND ART

Lithium-ion secondary batteries find general use in the field of notebook computers and portable telephones owing to the high energy density which characterizes them. In recent years, they are expected to find use as the power source for electric vehicles attracting attention from the standpoint of preventing global warming due to increasing carbon dioxide gas exhausted from automobiles.

Despite their outstanding characteristic properties, lithium-ion secondary batteries still have some problems to be addressed. One of them is improvement in safety. Particularly, it is important to ensure their safety when they undergo overcharging.

When overcharged, lithium-ion secondary batteries decrease in thermal stability, which deteriorates the safety. For this reason, various technologies are being developed to protect lithium-ion secondary batteries from overcharging.

Patent Documents 1 and 2 disclose a technology for adding an aromatic compound to lithium-ion secondary batteries to improve their stability in the case of overcharging.

Patent Documents 3 and 4 disclose a technology for incorporating lithium carbonate into the positive electrode to ensure safety in the case of overcharging in lithium-ion secondary batteries provided with a current breaking valve that works as the internal pressure increases. According to this technology, the lithium carbonate undergoes electrochemical decomposition in the positive electrode which is at a high potential, thereby generating carbon dioxide gas, which increases the battery's internal pressure and activates the current breaking valve. This is the mechanism to ensure the battery's safety in the case of overcharging.

### PRIOR ART REFERENCES

### Patent Documents

Patent Document 1: JP-2004-349131-A
Patent Document 2: JP-2003-297425-A
Patent Document 3: JP-2008-277106-A
Patent Document 4: JP-2008-186792-A
Patent Document 5: JP-1998-270003-A
Patent Document 6: JP-1998-92409-A

### SUMMARY OF THE INVENTION

### Problems to be Solved by the Invention

The simple addition of an aromatic compound to the battery as disclosed in Patent Documents 1 and 2, however, is not sufficient to ensure safety in the case of overcharging.

The incorporation with lithium carbonate as disclosed in Patent Documents 3 and 4 also involves the difficulty that the battery would undergo thermal runaway before lithium carbonate starts reaction in some cases because lithium carbonate has a high reaction potential of 4.8-5.0 V vs. Li/Li⁺ and starts reaction only in the terminal stage of overcharging. Another problem is that the incorporation of lithium carbonate into the positive electrode shortens the battery life during storage at high temperatures.

For the battery to have high safety in the case of overcharging, it is necessary that the current breaking valve should work in the early stage of overcharging. It is also necessary to establish a technology for suppressing overcharging without affecting the battery performance.

### Means for Solving the Problem

The present invention covers a lithium-ion secondary battery including a positive electrode capable of occluding and releasing lithium ions, a negative electrode capable of occluding and releasing lithium ions, a separator interposed between the positive electrode and the negative electrode, an electrolytic solution, and a current breaking mechanism that works as the battery's internal pressure increases. The lithium-ion secondary battery is characterized in that the electrolytic solution contains an aromatic compound and the separator contains an agent to generate carbon dioxide gas, which is represented by the general formula of AₓCO₃ or A_{y}HCO₃ (where A denotes an alkali metal or alkaline earth metal; x is 2 if A is an alkali metal or 1 if A is an alkaline earth metal; and y is 1 if A is an alkali metal or 0.5 if A is an alkaline earth metal). It is also characterized in that the aromatic compound is one represented by Formula (1) or (2) below or benzene.

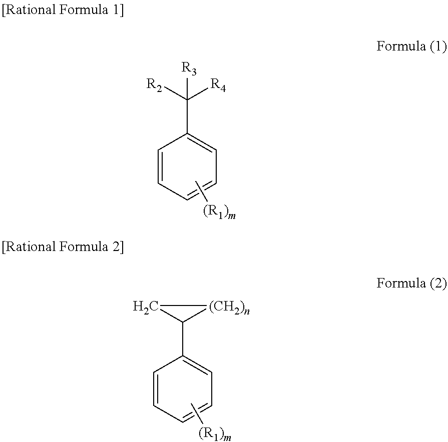

In Formula (1), R₁ denotes a hydrogen atom or hydrocarbon group, with m being no larger than 5 if R₁ denotes a hydrocarbon group, and each of R₂ to R₄ denotes a hydrogen atom or hydrocarbon group.

The aromatic compound represented by Formula (2) is one which has a substituent of alicyclic hydrocarbon. In Formula (2), R₁ denotes a hydrogen atom or hydrocarbon group, with m being no larger than 5 if R₁ denotes a hydrocarbon group, and n is no smaller than 1 and no larger than 14.

### Effects of the Invention

The lithium-ion secondary battery according to the present invention permits the current breaking valve to work in the early stage of overcharging, and this helps achieve improved safety without deteriorating the battery's performance unlike the conventional battery in which the positive electrode is incorporated with lithium carbonate. Other constitutions, effects, and problems not mentioned above will become clear from the embodiments mentioned hereunder.

### BRIEF DESCRIPTION OF THE DRAWINGS

FIG. 1 is an illustration for the evolution of gas at the time of overcharging.

FIG. 2 is a sectional view showing a battery of wound type.

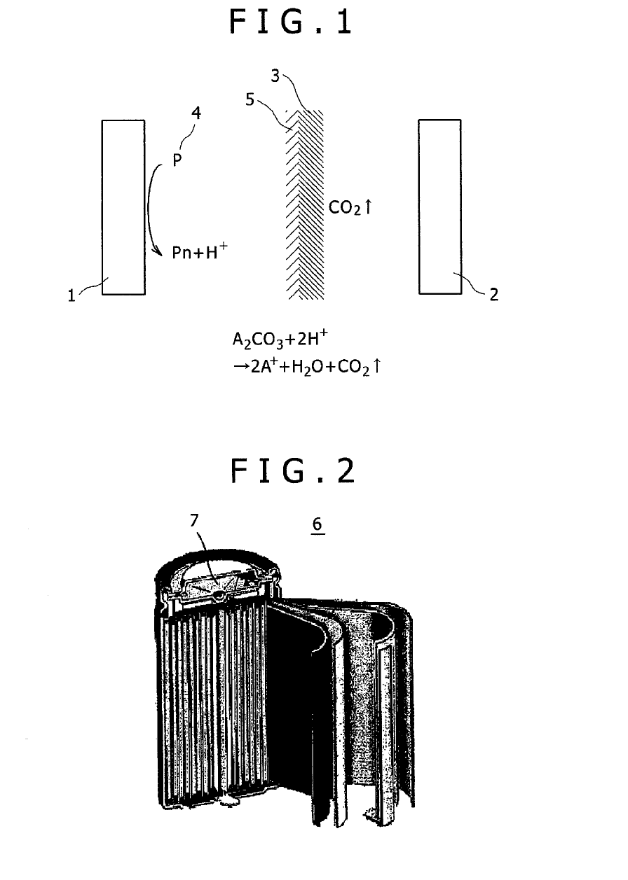

### MODES FOR CARRYING OUT THE INVENTION

The embodiments of the present invention will be described in detail with reference to the accompanying drawings. They are intended to concretely illustrate, not to restrict, the scope of the present invention. They may be properly modified and changed by those who are skilled in the art within the technical idea disclosed herein. Incidentally, the accompanying drawings identify same parts with same reference numerals without repeated explanation.

One of the conventional disclosed technologies to ensure safety in the case of overcharging is designed to incorporate the battery with an aromatic compound which generates a gas in the case of overcharging, thereby actuating the current breaking valve. The disadvantage of this technology is that the aromatic compound generates hydrogen gas which is inherently incapable of activating the current breaking valve and is potentially dangerous.

There has been disclosed a technology of incorporating the positive electrode with lithium carbonate which generates carbon dioxide gas in the case of overcharging. However, this technology lacks quick response to overcharging because lithium carbonate has a reaction potential of 4.8-5.0 V vs. Li/Li⁺ and its reaction starts only in the terminal stage of overcharging.

Moreover, lithium carbonate has another disadvantage of adversely affecting the coatability of the positive electrode containing it at the time of battery fabrication. This leads to low productivity. In addition, lithium carbonate incorporated into the positive electrode shortens the battery life during storage at high temperatures. The fact that lithium carbonate has a reaction potential of 4.8-5.0 V vs. Li/Li⁺ and its reaction starts only in the terminal stage of overcharging means that there is a possibility of the battery undergoing thermal runaway before lithium carbonate starts reaction. Thus, lithium carbonate alone cannot ensure safety in the case of overcharging.

The present invention employs an aromatic compound and a compound in combination which generate protons and carbon dioxide gas, respectively, through electrochemical reactions at a potential higher than a certain level, so that the current breaking valve is activated in the early stage of overcharging.

The aromatic compound 4 generates protons in the vicinity of the positive electrode 1 as the battery increases in potential due to overcharging. The protons generated from the aromatic compound 4 neutralizes the carbon dioxide gas generating agent 5 which is added to the separator 3, thereby generating carbon dioxide gas. The thus generated carbon dioxide gas activates the current breaking valve, which in turn suspends charging.

The aromatic compound used in the present invention, which generates protons through electrochemical reactions at a potential higher than a certain level, is illustrated by those represented by the formulas (1) and (2) and also by benzene. The lithium-ion secondary battery usually has a working potential of 2.5-4.3 V. It is in an overcharged state when its working potential exceeds 4.5 V. In order to prevent overcharging, the battery should preferably be provided with a means to generate a gas when the battery voltage exceeds 4.5 V. It is desirable that the aromatic compound starts reactions at a potential of 4.4-4.8 V so that it quickly responds to overcharging, thereby generating protons. The upper value is a limit beyond which the aromatic compound does not respond quickly to overcharging. The lower value is a limit beyond which the aromatic compound starts reaction while the battery is working normally. This would lead to the deterioration of the battery.

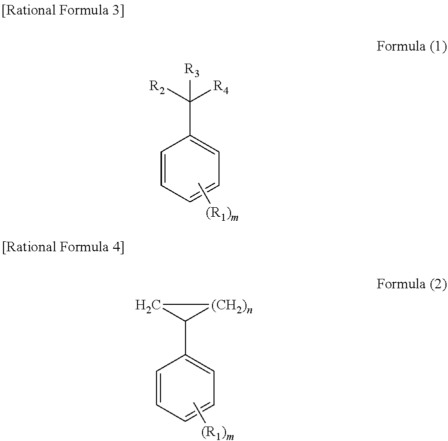

The above-mentioned working potential and overcharge voltage vary depending on the active material and design for the lithium-ion secondary battery. Consequently, it is desirable to adjust the reaction potential of the aromatic compound according to the working potential of the battery. The reaction potential of the aromatic compound can be adjusted by properly selecting its functional group. It is an advantage of the present invention that the potential for generation of carbon dioxide gas depends not only on the reaction potential of the carbon dioxide gas generating agent but also on the reaction potential of the aromatic compound having an adjustable reaction potential.

The aromatic compound represented by Formula (1) is one which has a substituent of alicyclic hydrocarbon. In Formula (1), R₁ denotes a hydrogen atom or hydrocarbon group. The hydrocarbon group is illustrated by aliphatic hydrocarbon groups (CₙH₂ₙ₊₁), alicyclic hydrocarbon groups (CₙH₂ₙ₋₁) and aromatic hydrocarbon groups. Examples of the aliphatic hydrocarbon group include methyl group, ethyl group, propyl group, isopropyl group, butyl group, isobutyl group, dimethylethyl group, pentyl group, hexyl group, heptyl group, octyl group, isooctyl group, decyl group, undecyl group, and dodecyl group. Examples of the alicyclic hydrocarbon group include cyclopropyl group, cyclobutyl group, cyclopentyl group, cyclohexyl group, cycloheptyl group, cyclooctyl group, cyclononyl group, and cyclodecyl group. The aromatic group is a functional group having no more than 20 carbon atoms that satisfies the Huckel's rule. n denotes a numeral no smaller than 1 and no larger than 14. If R₁ is a hydrocarbon group, m denotes a numeral no larger than 5.

In Formula (2), each of R₁ to R₄ denotes a hydrogen atom or hydrocarbon group. The hydrocarbon group is illustrated by aliphatic hydrocarbon groups (CₙH₂ₙ₊₁) alicyclic hydrocarbon groups (CₙH₂ₙ₋₁), and aromatic hydrocarbon groups. Examples of the aliphatic hydrocarbon group include methyl group, ethyl group, propyl group, isopropyl group, butyl group, isobutyl group, dimethylethyl group, pentyl group, hexyl group, heptyl group, octyl group, isooctyl group, decyl group, undecyl group, and dodecyl group. Examples of the alicyclic hydrocarbon group include cyclopropyl group, cyclobutyl group, cyclopentyl group, cyclohexyl group, cycloheptyl group, cyclooctyl group, cyclononyl group, and cyclodecyl group. The aromatic group is a functional group having no more than 20 carbon atoms that satisfies the Hückel's rule. If R₁ is a hydrocarbon group, m denotes a numeral no larger than 5.

According to the present invention, the compound represented by Formula (1) or Formula (2) or benzene is added to the electrolytic solution in such an amount that its concentration is more than 0 wt % and less than 50 wt %, preferably no lower than 0.01% and no higher than 10 wt %. An adequate amount of addition ensures the battery's good performance as well as the battery's high safety in the case of overcharging as intended by the present invention.

The compound that generates carbon dioxide gas neutralizes protons generated by the aromatic compound, thereby generating carbon dioxide gas. Therefore, the compound that generates carbon dioxide gas includes not only lithium carbonate (which generates carbon dioxide gas in response to the varying potential) but also any compound that generate carbon dioxide gas through neutralization of protons.

According to the present invention, the compound that generates carbon dioxide gas through neutralization (the compound being referred to as a carbon dioxide gas generating agent) is one which is represented by the formula AₓCO₃ or A_{y}HCO₃ (where A denotes an alkali metal or alkaline earth metal, and x is 2 if A denotes an alkali metal or 1 if A denotes an alkaline earth metal, and y is 1 if A denotes an alkali metal or 0.5 if A denotes an alkaline earth metal). Typical examples of the compound include lithium carbonate, sodium carbonate, potassium carbonate, rubidium carbonate, cesium carbonate, beryllium carbonate, magnesium carbonate, calcium carbonate, strontium carbonate, barium carbonate, lithium hydrogen carbonate, sodium hydrogen carbonate, potassium hydrogen carbonate, rubidium hydrogen carbonate, cesium hydrogen carbonate, beryllium hydrogen carbonate, magnesium hydrogen carbonate, calcium hydrogen carbonate, strontium hydrogen carbonate, and barium hydrogen carbonate. Preferable among them from the standpoint of battery performance and battery safety are lithium carbonate, sodium carbonate, potassium carbonate, magnesium carbonate, calcium carbonate, strontium carbonate, barium carbonate, lithium hydrogen carbonate, sodium hydrogen carbonate, potassium hydrogen carbonate, magnesium hydrogen carbonate, calcium hydrogen carbonate, strontium hydrogen carbonate, and barium hydrogen carbonate. The carbon dioxide gas generating agents mentioned above may be used alone or in combination with one another. The carbon dioxide gas generating agents mentioned above may also be used with lithium carbonate.

The carbon dioxide gas generating agent should preferably be one which remains stable regardless of potential. It is illustrated by sodium carbonate, potassium carbonate, magnesium carbonate, calcium carbonate, sodium hydrogen carbonate, potassium hydrogen carbonate, magnesium hydrogen carbonate, and calcium hydrogen carbonate.

Preferable pricewise among the carbon dioxide gas generating agents mentioned above are sodium carbonate, potassium carbonate, magnesium carbonate, calcium carbonate, and sodium hydrogen carbonate.

According to the present invention, the carbon dioxide gas generating agent is placed in the separator so as to avoid troubles involved in the manufacturing process and prevent the decline of battery performance. Incidentally, the term “separator” in this specification denotes a polyolefin film having the carbon dioxide gas generating agent coated thereon directly or indirectly with a heat-resistant layer of ceramics interposed between them. Moreover, the carbon dioxide gas generating agent may be applied onto the separator in such a way that it faces either or both of the positive and negative electrodes.

The amount (denoted by X) of the carbon dioxide gas generating agent is important for the present invention to produce its effect. It should be such that 0<X<100 wt %, preferably 0<X<10 wt %, for the weight of the positive electrode (or the positive electrode active material, conducting material, and binder combined together). The thus specified value of X permits the present invention to produce its effect without sacrificing the battery's performance.

The carbon dioxide gas generating agent may be applied onto the separator in any way without specific restrictions. One method desirable from the standpoint of productivity consists of making the carbon dioxide gas generating agent into a slurry by incorporation with a binder, applying the slurry onto the separator, and drying the slurry to remove solvent. The separator may be a film of polyolefin (such as polyethylene and polypropylene) or a woven or nonwoven cloth of cellulosic fiber, polyamide fiber, polyester fiber, or glass fiber. The separator may be formed from a single layer of polyethylene or polypropylene film or from multiple layers of polyethylene and polypropylene films. Such separators are desirable on account of high resistance to the electrolytic solution and the oxidation-reduction reaction.

The solvent for the slurry is not specifically restricted so long as it dissolves the binder resin and it evaporates for removal after application onto the separator. Desirable examples of the solvent include carbonyl compound (such as acetone and methyl ethyl ketone), aromatic compounds (such as xylene and benzene), N-methylpyrrolidone, N,N-dimethylformamide, and N,N-dimethylacetamide. The binder that adheres the carbon dioxide gas generating agent onto the separator may be selected from polyolefin (such as polyethylene and polypropylene), fluoroplastics (such as polytetrafluoroethylene and polyvinylidene fluoride), and styrene butadiene rubber resin. The binder should have a number-average molecular weight (Mₙ) no lower than 500 and no higher than 15,000,000, preferably no lower than 1000 and no higher than 5,000,000.

The lithium-ion secondary battery according to the present invention has a positive electrode made of an oxide represented by the formula LiMO₂ (where M denotes a transition metal), which is capable of occluding and releasing lithium ions. The oxide may be that of lamellar structure which is illustrated by LiCoO₂, LiNiO₂, LiMn_{1/3}Ni_{1/3}CO_{1/3}O₂, and LiMn_{0.4}Ni_{0.4}Co_{0.2}O₂, in which M may be replaced by at least one metal element selected from the group consisting of Al, Mg, Mn, Fe, Co, Cu, Zn, Ti, Ge, W, and Zr. The oxide may also be that of spinel structure which is illustrated by LiMn₂O₄ and Li₁₊ₓMn₂₋ₓO₄. Moreover, the oxide may be that of olivine structure illustrated by LiFePO₄ and LiMnPO₄.

The lithium-ion secondary battery according to the present invention has a negative electrode made of natural or artificial graphite or any other carbonaceous material. The artificial graphite is one which is obtained from petroleum coke or coal pitch coke by graphitization at 2500° C. and above. The carbonaceous material includes mesophase carbon, amorphous carbon, and carbon fiber. The negative electrode may also be made of any metal alloyable with lithium or carbon particles carrying metal on their surface. Examples of such metal include lithium, silver, aluminum, tin, silicon, indium, gallium, and magnesium, and alloys thereof. The negative electrode may also be made of any one of the metals or oxides thereof. An additional material for the negative electrode is lithium titanate.

According to the present invention, the lithium-ion secondary battery has an electrolytic solution containing an aromatic compound capable of generating protons. This electrolytic solution is composed a nonaqueous solvent and a supporting electrolyte dissolved therein. The nonaqueous solvent is not specifically restricted so long as it is capable of dissolving the supporting electrolyte. It should preferably be an organic solvent such as diethyl carbonate, dimethyl carbonate, ethylene carbonate, ethyl methyl carbonate, propylene carbonate, γ-butyrolactone, tetrahydrofuran, and dimethoxyethane. They may be used alone or in combination with one another. The organic solvent may be mixed with vinylene carbonate or vinyl ethylene carbonate which has an unsaturated double bond in the molecule.

The supporting electrolyte used in the present invention is not specifically restricted so long as it is soluble in the nonaqueous solvent. Its preferred examples include electrolyte salts as follows: LiPF₆, LiN(CF₃SO₂)₂, LiN(C₂F₆SO₂)₂, LiClO₄, LiBF₄, LiAsF₆, LiI, LiBr, LiSCN, Li₂B₁₀Cl₁₀, and LiCF₃CO₂. They may be used alone or in combination with one another.

The lithium-ion secondary battery according to the present invention has a current breaking mechanism, which may be an ordinary gas releasing valve that opens at a prescribed internal pressure, as disclosed in Patent Documents 5 and 6. This gas releasing valve opens before the battery bursts when the internal pressure of the battery abruptly rises due to thermal runaway, so that gas is released from the battery can. Thus, the lithium-ion battery provided with such a gas releasing valve will not scatter about its content from its container even though its internal pressure rises. Incidentally, the gas releasing valve is so constructed as to deform and open, thereby breaking the electric circuit.

FIG. 2 is a schematic diagram showing the lithium-ion secondary battery 3 provided with the ordinary current breaking valve 4.

### EXAMPLES

The invention will be described in more detail with reference to the following Examples which are not intended to restrict the scope thereof. The results obtained in Examples are summarized in Table 1.

### <Method for Producing Electrodes>

### <Positive Electrode>

A mixture was made from lithium cobaltate, conductive carbon, and polyvinylidene fluoride in a ratio of 95:2.5:2.5 by wt %. The resulting mixture was dispersed into N-methyl-2-pyrrolidone to give a slurry. The resulting slurry was applied onto an aluminum foil (20 μm thick) by using a doctor blade, followed by drying.

### <Negative Electrode>

A mixture was made from artificial graphite and polyvinylidene fluoride in a ratio of 95:5 by wt %. The resulting mixture was dispersed into N-methyl-2-pyrrolidone to give a slurry. The resulting slurry was applied onto a copper foil (20 μm thick) by using a doctor blade, followed by drying.

### <Method for Producing Separator>

A solution was made from N-methyl-2-pyrrolidone and polyvinylidene fluoride (3 wt %) as a binder dissolved therein. The resulting solution was mixed with a carbon dioxide gas generating agent by stirring. The resulting dispersion was applied onto a porous polyethylene film (30 μm thick) by using a doctor blade. After drying for solvent removal, there was obtained a separator for evaluation.

### <Method for Producing Battery of 18650 Type and Evaluation of Battery Performance>

A battery sample for evaluation was prepared as follows. First, the positive electrode, the separator, and the negative electrode were wound all together to give a wound body. Next, the wound body was placed in a battery can for 18650 type. Finally, the battery can was filled with an electrolytic solution and sealed. Incidentally, the battery can has a current breaking mechanism that works as the internal pressure rises. The thus obtained battery underwent three cycles of charging and discharging at a current value of 200 mA, with the voltage kept within the range of 3.0 V to 4.2 V. The current value measured in the third cycle of discharging was regarded as the battery capacity.

For the purpose of evaluating the battery characteristics during storage at high temperatures, the battery prepared as mentioned above was charged up to 4.2 V and then stored for 10 days in a thermostatic bath at 60° C. Then, the battery was cooled to room temperature and discharged once down to 3.0 V. Finally, the battery underwent charging and discharging repeatedly in the same way as mentioned above, and the discharging capacity was measured. The thus measured value was regarded as the battery capacity after storage.

### <Method for Overcharge Test>

A battery sample, which was prepared separately for evaluation of battery performance under overcharging, was tested as follows. It was charged up to 4.2 V and then overcharged up to 5.0 V with a current value of 2000 mA. After the battery voltage had reached 5.0 V, charging was continued at a constant potential of 5.0 V until the current value reached 50 mA. As the result of the overcharge test, the battery sample was rated as good if it neither bursts nor ignites and as poor if it bursts and/or ignites.

### Example 1

An electrolytic solution was prepared from an electrolyte salt (LiPF₆) and a solvent (EC/DMC/MEC=1:1:1 by volume), with the amount of the former being 1 mol/L). To this electrolytic solution was added the aromatic compound A represented by the formula 1, wherein R₁=H and n=4, in an amount of 2.0 wt %. A separator was prepared by coating with Li₂CO₃ as a carbon dioxide gas generating agent in an amount of 3.0 wt % for the weight of the positive electrode. A battery sample was prepared with the foregoing electrolytic solution and separator. The results of evaluation indicated that the battery capacity was 2010 mAh and the battery capacity after storage at high temperatures was 1903 mAh. It was found that the current breaking valve worked at 4.6 V during the overcharging test. The battery sample tested for overcharging was rated as good without bursting and ignition.

### Example 2

The same procedure as in Example 1 was repeated except that the aromatic compound A was replaced by the aromatic compound B represented by the formula 2, where R₁=H, R₂=Me, R₃=Me, and R₄=H. The results of evaluation indicated that the battery capacity was 2010 mAh and the battery capacity after storage at high temperatures was 1906 mAh. It was found that the current breaking valve worked at 4.6 V during the overcharging test. The battery sample tested for overcharging was rated as good without bursting and ignition.

### Example 3

The same procedure as in Example 1 was repeated except that the aromatic compound A was replaced by the aromatic compound C represented by the formula 2, where R₁=H, R₂=Me, R₃=Et, and R₄=H. The results of evaluation indicated that the battery capacity was 2010 mAh and the battery capacity after storage at high temperatures was 1904 mAh. It was found that the current breaking valve worked at 4.6 V during the overcharging test. The battery sample tested for overcharging was rated as good without bursting and ignition.

### Example 4

The same procedure as in Example 1 was repeated except that the aromatic compound A was replaced by the aromatic compound D represented by the formula 2, where R₁=H, R₂=H, R₃=H, and R₄=H. The results of evaluation indicated that the battery capacity was 2010 mAh and the battery capacity after storage at high temperatures was 1904 mAh. It was found that the current breaking valve worked at 4.9 V during the overcharging test. The battery sample tested for overcharging was rated as good without bursting and ignition.

### Example 5

The same procedure as in Example 2 was repeated except that Li₂CO₃ was replaced by Na₂CO₃ in an amount of 4.0 wt %. The results of evaluation indicated that the battery capacity was 2010 mAh and the battery capacity after storage at high temperatures was 1900 mAh. It was found that the current breaking valve worked at 4.6 V during the overcharging test. The battery sample tested for overcharging was rated as good without bursting and ignition.

### Example 6

The same procedure as in Example 2 was repeated except that Li₂CO₃ was replaced by NaHCO₃ in an amount of 4.0 wt %. The results of evaluation indicated that the battery capacity was 2010 mAh and the battery capacity after storage at high temperatures was 1900 mAh. It was found that the current breaking valve worked at 4.6 V during the overcharging test. The battery sample tested for overcharging was rated as good without bursting and ignition.

### Comparative Example 1

A battery sample was prepared which does not contain the aromatic compound and the carbon dioxide gas generating agent. The battery sample was found to have a battery capacity of 2010 mAh and also a battery capacity of 1901 mAh after storage at high temperatures. During the overcharge testing, the battery sample suffered bursting and ignition and hence it was rated as poor.

### Comparative Example 2

A battery sample was prepared in the same way as in Example 1 except that it does not contain the carbon dioxide gas generating agent. The battery sample was found to have a battery capacity of 2010 mAh and also a battery capacity of 1900 mAh after storage at high temperatures. During the overcharge testing, the battery sample suffered bursting and ignition and hence it was rated as poor.

### Comparative Example 3

A battery sample was prepared in the same way as in Comparative Example 2 except that the content of the aromatic compound was changed to 3 wt %. The battery sample was found to have a battery capacity of 2001 mAh and also a battery capacity of 1850 mAh after storage at high temperatures. During the overcharge testing, the battery sample suffered bursting although it did not suffer ignition and hence it was rated as poor.

### Comparative Example 4

A battery sample was prepared in the same way as in Example 1 except that the aromatic compound was not added and the lithium carbonate was incorporated into the positive electrode instead of the separator. The battery sample was found to have a battery capacity of 1995 mAh and also a battery capacity of 1860 mAh after storage at high temperatures. During the overcharge testing, the battery sample suffered bursting although it did not suffer ignition and hence it was rated as poor.

Comparative Examples 2 and 3 demonstrate the batteries having no carbon dioxide gas generating agent. The batteries tested failed to activate the current breaking valve. A probable reason for this is that the batteries in Comparative Examples 2 and 3 are designed such that the current breaking valve is activated by hydrogen gas generated from the aromatic compound and hydrogen is inherently incapable of activating the current breaking valve.

Examples 1 to 6 demonstrate the batteries incorporated with both the aromatic compound and the gas generating agent. The batteries tested successfully activated the current breaking valve at a potential of 4.6 V. The batteries in Examples 1 to 6 are more quickly responsive to overcharging than those in Comparative Examples 4 and 5 as evidenced by the fact that the former activate the current breaking valve at a lower potential than the latter.

The result of Example 2 is best among those of Examples 1 to 6. The battery in Example 2 is excellent in responsiveness to overcharging and storage stability at high temperatures. It is only slightly inferior in decline of battery performance to the one in Example 5 or 6 probably because it is incorporated with Na₂CO₃ which is stabler than LiCO₃.

TABLE 1

| | | | | | | Evaluation of battery | | Test for overcharging | | | | |
|---|---|---|---|---|---|---|---|---|---|---|---|---|
| | | | | | | | Battery | | Voltage | | | |
| | | | | | | | capacity | Current | for current | | | |
| | Aromatic compound | | | Gas generating agent | | Battery | after | breaking | breaking | | | |
| | | | Amount | | Amount * | capacity | storage | valve | valve to | Burst- | Igni- | Rat- |
| | Name | Structure | (wt %) | Formula | (wt %) | (mAh) | (mAh) | worked? | work | ing | tion | ing |
| Example | | | | | | | | | | | | |
| 1 | Aromatic | Formula (1) | 2.0 | Li₂CO₃ | 3.0 | 2010 | 1903 | yes | 4.6 | no | no | good |
| | compound A | R₁ = H, | | | | | | | | | | |
| | | n = 4 | | | | | | | | | | |
| 2 | Aromatic | Formula (2) | 2.0 | Li₂CO₃ | 3.0 | 2010 | 1906 | yes | 4.6 | no | no | good |
| | compound B | R₁ = H, | | | | | | | | | | |
| | | R_{2, 3} = Me, | | | | | | | | | | |
| | | R₄ = H | | | | | | | | | | |
| 3 | Aromatic | Formula (2) | 2.0 | Li₂CO₃ | 3.0 | 2010 | 1904 | yes | 4.6 | no | no | good |
| | compound C | R₁ = H, | | | | | | | | | | |
| | | R₂ = Me, | | | | | | | | | | |
| | | R₃ = Et, | | | | | | | | | | |
| | | R₄ = H | | | | | | | | | | |
| 4 | Aromatic | Formula (2) | 2.0 | Li₂CO₃ | 3.0 | 2009 | 1900 | yes | 4.9 | no | no | good |
| | compound D | R₁ = H, | | | | | | | | | | |
| | | R_{2, 3, 4} = H | | | | | | | | | | |
| 5 | Aromatic | Formula (2) | 2.0 | Na₂CO₃ | 4.0 | 2010 | 1900 | yes | 4.6 | no | no | good |
| | compound B | R₁ = H, | | | | | | | | | | |
| | | R_{2, 3} = Me, | | | | | | | | | | |
| | | R₄ = H | | | | | | | | | | |
| 6 | Aromatic | Formula (2) | 2.0 | Na₂CO₃ | 4.0 | 2010 | 1900 | yes | 4.6 | no | no | good |
| | compound B | R₁ = H, | | | | | | | | | | |
| | | R_{2, 3} = Me, | | | | | | | | | | |
| | | R₄ = H | | | | | | | | | | |
| Compar. | | | | | | | | | | | | |
| Example | | | | | | | | | | | | |

| 1 | Not added | | | Not added | 2010 | 1901 | no | — | yes | yes | poor |
|---|---|---|---|---|---|---|---|---|---|---|---|
| 2 | Aromatic | Formula (1) | 2.0 | Not added | 2010 | 1900 | no | — | yes | yes | poor |
| | compound A | R₁ = H, | | | | | | | | | |
| | | n = 4 | | | | | | | | | |
| 3 | Aromatic | Formula (1) | 3.0 | Not added | 2001 | 1850 | no | — | yes | no | poor |
| | compound A | R₁ = H, | | | | | | | | | |
| | | n = 4 | | | | | | | | | |

| | | | | | | | | | | |
|---|---|---|---|---|---|---|---|---|---|---|
| 4 | Not added | Li₂CO₃ | 3.0 ** | 1995 | 1860 | yes | 5.0 | yes | no | poor |

* Amount based on the positive electrode.
** Mixed in the positive electrode.

### EXPLANATION OF NUMERALS

1 Positive electrode
2 Negative electrode
3 Separator
4 Aromatic compound
5 Carbon dioxide gas generating agent
6 Lithium-ion secondary battery
7 Current breaking valve

1. A lithium-ion secondary battery, comprising:
a positive electrode capable of occluding and releasing lithium ions;
a negative electrode capable of occluding and releasing lithium ions;
a separator interposed between the positive electrode and the negative electrode;
an electrolytic solution; and
a current breaking mechanism that activates in response to the rise of the battery's internal pressure; wherein
the electrolytic solution is incorporated with an aromatic compound and the separator is incorporated with a carbon dioxide gas generating agent which is represented by the formula AₓCO₃ or A_{y}HCO₃ (where A denotes an alkali metal or alkaline earth metal, and x is 2 if A denotes an alkali metal and 1 if A denotes an alkaline earth metal and y is 1 if A denotes an alkali metal and 0.5 if A denotes an alkaline earth metal).

2. The lithium-ion secondary battery as defined in claim 1, wherein the aromatic compound generates protons at a potential no lower than 4.4 V and no higher than 4.8 V.

3. The lithium-ion secondary battery as defined in claim 2, wherein the aromatic compound is one represented by Formula 1 or Formula 2 or benzene, 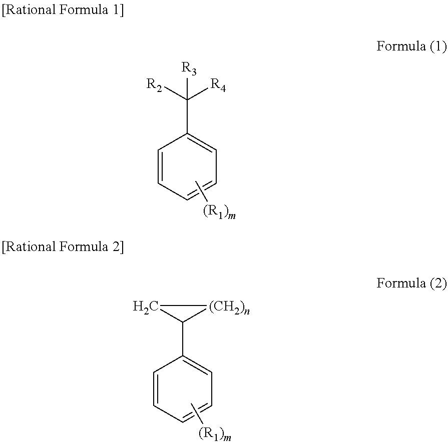
in Formula 1, R₁ denotes a hydrogen atom or hydrocarbon group, m is no larger than 5 if R₁ denotes a hydrocarbon group, and each of R₂, R₃, and R₄ denotes a hydrogen atom or hydrocarbon group, and
in Formula 2, which represents an aromatic compound having a substituent of alicyclic hydrocarbon, R₁ denotes a hydrogen atom or hydrocarbon group, m is no larger than 5 if R₁ denotes a hydrocarbon group, and n is no smaller than 1 and no larger than 14.

4. The lithium-ion secondary battery as defined in claim 3, wherein the electrolytic solution contains the aromatic compound in an amount no lower than 0.01 wt % and no higher than 10 wt %.

5. The lithium-ion secondary battery as defined in claim 4, wherein the carbon dioxide gas generating agent includes at least one species selected from lithium carbonate, sodium carbonate, potassium carbonate, magnesium carbonate, calcium carbonate, sodium hydrogen carbonate, potassium hydrogen carbonate, magnesium hydrogen carbonate, and calcium hydrogen carbonate.
